(19) United States
(12) Patent Application Publication
(10) Pub. No.: US 2019/0323519 A1
(43) Pub. Date: Oct. 24, 2019

(54) COMPRESSOR DIFFUSER AND GAS TURBINE

(71) Applicant: MITSUBISHI HEAVY INDUSTRIES, LTD., Tokyo (JP)

(72) Inventors: Kuniaki AOYAMA, Tokyo (JP); Hiroyuki YAMAMOTO, Tokyo (JP)

(21) Appl. No.: 16/385,694

(22) Filed: Apr. 16, 2019

(30) Foreign Application Priority Data
Apr. 18, 2018 (JP) 2018-079987

(51) Int. Cl. F04D 29/44

(52) U.S. Cl. CPC F04D 29/444; F05D 2240/121; F05D 2250/52

(57) ABSTRACT

A compressor diffuser (5) is connected to a compressor (1) generating compressed air by compressing air and a combustion cylinder (21) supplying a combustion gas to a turbine. The compressor diffuser (5) includes a first diffuser (51) and a second diffuser (52). One end of the first diffuser (51) is connected to a part of an annular outlet (16) of the compressor (1) in a circumferential direction and the other end of the first diffuser (5) is connected to an air supply port (24) of the combustion cylinder (21). The second diffuser (52) is connected to the outlet (16) of the compressor (1) at a position different in the circumferential direction from the part where the end of the first diffuser (51) is connected and guides the compressed air to the outside of the first diffuser (51).

### BACKGROUND OF THE INVENTION

### Field of the Invention

The present invention relates to a compressor diffuser and a gas turbine. Priority is claimed on Japanese Patent Application No. 2018-079987, filed on Apr. 18, 2018, the content of which is incorporated herein by reference.

### Description of Related Art

In general, a gas turbine is provided with a compressor generating compressed air by compressing outside air, a combustor generating a high-temperature and high-pressure combustion gas by combusting a fuel in the compressed air, and a turbine driven to rotate by the combustion gas.

In the gas turbine, the compressed air compressed by the compressor is supplied to each of a plurality of combustion cylinders disposed around a rotary shaft in the combustor. In general, a diffuser (compressor diffuser) for converting the dynamic pressure of the compressed air into a static pressure is provided on the outlet side of the compressor. The diffuser is formed so as to have a flow path cross-sectional area gradually increasing toward a casing side and converts the dynamic pressure of the compressed air flowing into the combustor into a static pressure.

Such gas turbines have a structure in which the compressed air is supplied to the combustion cylinder directly and not via the casing as in Japanese Unexamined Patent Application, First Publication No. 2017-198077. In the gas turbine that is disclosed in Japanese Unexamined Patent Application, First Publication No. 2017-198077, the diffuser that directly connects the outlet of the compressor and the inlet of the combustion cylinder is provided with a bleeding portion. The bleeding portion is formed as a hole penetrating the side surface of the diffuser. Some of the compressed air that is sent from the compressor to the combustion cylinder via the diffuser is taken out into the casing by the hole as the bleeding portion. The compressed air taken out into the casing cools the combustion cylinder, is cooled by a cooling device, and is used for cooling of a turbine stationary blade, a turbine rotor blade, a turbine shaft, and the like.

### SUMMARY OF THE INVENTION

In the configuration that is disclosed in Japanese Unexamined Patent Application, First Publication No. 2017-198077, some of the compressed air that flows in the diffuser is taken out through the hole formed in the side surface of the diffuser. Accordingly, the direction in which the compressed air is bled through the hole intersects with the flow direction of the compressed air in the diffuser. In addition, bleeding from the hole in the wall surface of the diffuser entails a significant pressure loss attributable to the pressure difference between the inside and the outside of the diffuser. The pressure loss leads to a decline in the operation efficiency of the gas turbine.

The present invention provides a compressor diffuser and a gas turbine allowing pressure loss limitation during partial compressed air bleeding.

A compressor diffuser according to a first aspect of the present invention is a compressor diffuser connected to a compressor generating compressed air by compressing air and a combustion cylinder generating a combustion gas by combusting a fuel in the compressed air and supplying the combustion gas to a turbine. The compressor diffuser includes a first diffuser, one end of the first diffuser being connected to a part of an annular outlet of the compressor in a circumferential direction and an other end of the first diffuser being connected to an air supply port of the combustion cylinder, and a second diffuser connected to a part of the outlet of the compressor at a position different in the circumferential direction from a part where the end of the first diffuser is connected and guiding the compressed air to an outside of the first diffuser.

In this configuration, some of the compressed air is directly bled from the outlet of the compressor and the compressed air is guided to the outside of the first diffuser by the second diffuser. At this time, in the second diffuser, the compressed air that has flowed from the outlet of the compressor flows without a change in flow direction. In addition, the second diffuser adopts a shape in which the flow path area increases, and thus pressure recovery can be performed. Accordingly, it is possible to limit pressure loss during compressed air bleeding.

In the compressor diffuser according to a second aspect of the present invention, in the first aspect, a plurality of the first diffusers may be disposed at intervals in the circumferential direction and the second diffuser may be disposed between the plurality of the first diffusers adjacent to each other in the circumferential direction.

With this configuration, the first diffuser and the second diffuser can be alternately disposed in the circumferential direction. As a result, the second diffuser can be disposed between the first diffusers adjacent to each other in the circumferential direction. Accordingly, in a gas turbine provided with the compressor diffuser, the second diffuser can be efficiently disposed in a limited space.

The compressor diffuser according to a third aspect of the present invention, in the first aspect or the second aspect, may further include a flow path forming portion connecting the outlet of the compressor and the first and second diffusers and circumferentially continuous so as to straddle at least the first and second diffusers adjacent to each other in the circumferential direction.

In this configuration, the compressed air that has flowed out from the compressed air outlet branches into the first diffuser and the second diffuser through the flow path forming portion. In other words, the flow velocity of the compressor air is reduced by the compressed air that has flowed out from the outlet of the compressor flowing once in the flow path forming portion. As a result, pressure loss is limited during the compressed air flow into the first diffuser and the second diffuser as compared with a case where the first diffuser and the second diffuser are directly connected to the outlet of the compressor.

A gas turbine according to a fourth aspect of the present invention includes a compressor generating compressed air by compressing air and sending out the compressed air from an annular outlet, a combustion cylinder generating a combustion gas by combusting a fuel in the compressed air and supplying the combustion gas to a turbine, a turbine having a rotor blade driven to rotate by the combustion gas, and the compressor diffuser according to any one of the first to third aspects provided between the compressor and the combustion cylinder.

According to the present invention, it is possible to limit pressure loss during partial compressed air bleeding.

### BRIEF DESCRIPTION OF THE DRAWINGS

FIG. 1 is a schematic configuration diagram of a gas turbine according to a first embodiment of the present invention.

FIG. 2 is an enlarged cross-sectional view around a combustor of the gas turbine according to the first embodiment of the present invention.

FIG. 3 is a perspective view showing a schematic shape of a compressor diffuser provided in the gas turbine according to the first embodiment of the present invention.

FIG. 4 is a diagram in which the compressor diffuser according to the first embodiment of the present invention is viewed from a radially outer side.

FIG. 5 is an enlarged cross-sectional view around a combustor of a gas turbine according to a second embodiment of the present invention.

FIG. 6 is a diagram in which a compressor diffuser according to the second embodiment of the present invention is viewed from a radially outer side.

FIG. 7 is a diagram in which a compressor diffuser according to a modification example of the second embodiment of the present invention is viewed from a radially outer side.

### DETAILED DESCRIPTION OF THE INVENTION

### First Embodiment

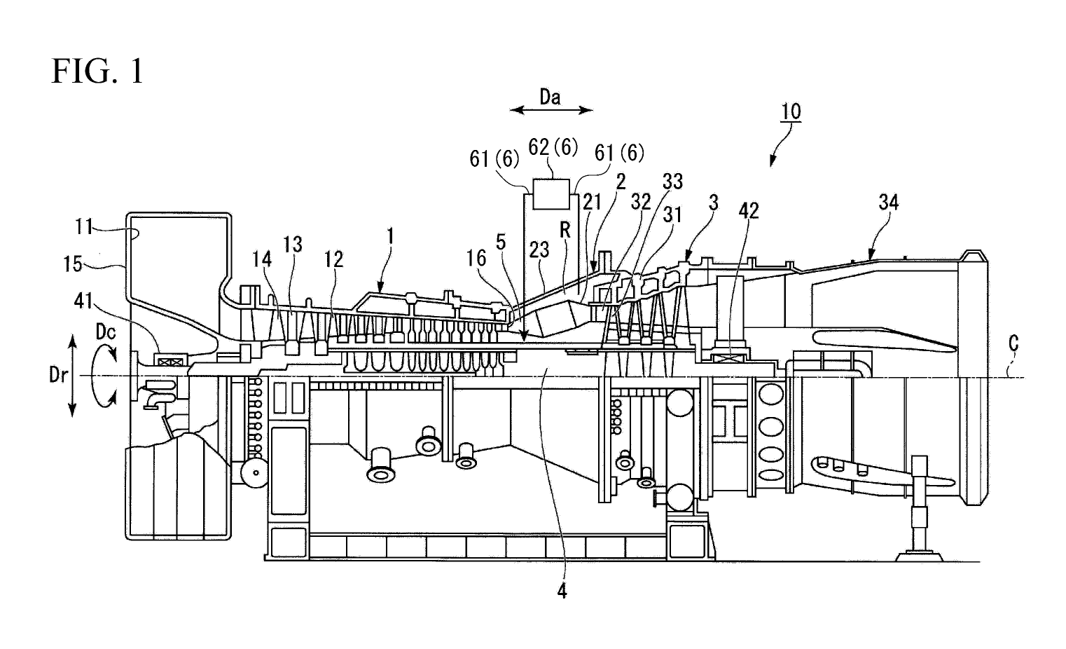

A gas turbine 10 of a first embodiment of the present invention will be described in detail with reference to accompanying drawings. As shown in FIG. 1, the gas turbine 10 of the present embodiment is provided with a compressor 1, a combustor 2, and a turbine 3. The gas turbine 10 is disposed such that a turbine shaft (rotary shaft) 4, which is a rotary shaft, penetrates the central portions of the compressor 1, the combustor 2, and the turbine 3. The compressor 1, the combustor 2, and the turbine 3 are sequentially arranged side by side along an axis C of the turbine shaft 4 and from an air flow upstream side toward an air flow downstream side.

In the following description, a turbine axial direction Da is parallel to the axis C and the turbine shaft 4 extends in the turbine axial direction Da. A turbine circumferential direction Dc is the direction in which the turbine shaft 4 rotates about the axis C. A turbine radial direction Dr is a radiation direction extending about the axis C and is orthogonal to the axis C.

The compressor 1 generates compressed air by compressing air. In the compressor 1, a compressor stator vane 13 and a compressor rotor blade 14 are provided in a cylindrical compressor casing 12 having an air intake port 11 for air intake. A plurality of the compressor stator vanes 13 are attached to the compressor casing 12 and arranged side by side in the turbine circumferential direction Dc. A plurality of the compressor rotor blades 14 are attached to the turbine shaft 4 and arranged side by side in the turbine circumferential direction Dc. The compressor stator vanes 13 and the compressor rotor blades 14 are provided so as to be alternately arranged in the turbine axial direction Da.

An outlet 16 of the compressor 1 is formed in an annular shape about the turbine shaft 4. The outlet 16 of the compressor 1 is formed so as to be smaller than an inlet 15 of the compressor 1 for air compression.

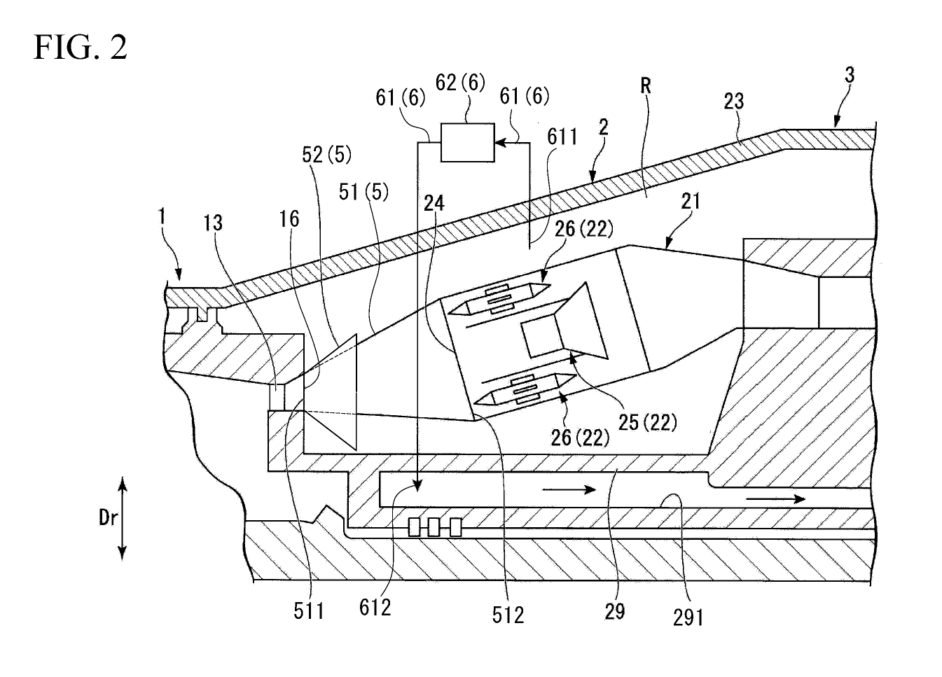

The combustor 2 generates a high-temperature and high-pressure combustion gas by means of a fuel and the compressed air compressed by the compressor 1. As shown in FIG. 2, the combustor 2 has a plurality of combustion cylinders 21 and a fuel sprayer 22.

The combustion cylinder 21 mixes and combusts the compressed air and the fuel. The combustion cylinder 21 is disposed in a cylindrical combustor casing 23, in which a combustor casing R is formed as a space. The plurality of combustion cylinders 21 are arranged side by side and at intervals in the turbine circumferential direction Dc about the turbine shaft 4. The combustion cylinder 21 is connected to the compressor 1 via a combustor diffuser 51 (described later). The central axis of the combustion cylinder 21 is disposed along the turbine axial direction Da. The combustion cylinder 21 is provided with an air supply port 24, which is an opening portion of a tubular body. The combustion cylinder 21 is disposed on the outlet 16 side of the compressor 1 and toward the air supply port 24.

The fuel sprayer 22 sprays the fuel and the compressed air into the combustion cylinder 21. The fuel sprayer 22 is provided with a pilot burner 25 diffusing and combusting the sprayed fuel and a plurality of main burners 26 premixing and combusting the sprayed fuel.

The pilot burner 25 is disposed on the central axis of the cylindrical combustion cylinder 21. The pilot burner 25 is supplied with the fuel (gas fuel) from a fuel supply source (not shown). The pilot burner 25 sprays the fuel and the compressed air into the combustion cylinder 21. This fuel is diffused and combusted in the combustion cylinder 21.

The plurality of main burners 26 are arranged side by side in the turbine circumferential direction Dc and about the central axis of the combustion cylinder 21 so as to surround the outer peripheral side of the pilot burner 25. In the main burner 26, a premixed gas is generated by the fuel and the compressed air being mixed. Each main burner 26 injects this premixed gas into the combustion cylinder 21. This premixed gas is premixed and combusted in the combustion cylinder 21. The high-temperature and high-pressure combustion gas generated as a result of the fuel combustion is sent to the turbine 3.

As shown in FIG. 2, the gas turbine 10 has an intermediate shaft cover 29 forming a ring shape along the turbine circumferential direction Dc on the outer periphery of the turbine shaft 4. The combustor casing R, which is a space outside the plurality of combustion cylinders 21, is partitioned by the inner peripheral surface of the combustor casing 23 and the outer peripheral surface of the intermediate shaft cover 29.

The turbine 3 is driven by the rotational power that is generated by the combustion gas generated by the combustion cylinder 21. As shown in FIG. 1, a turbine stator vane 32 and a turbine rotor blade (rotor blade) 33 are provided in a cylindrical turbine casing 31 of the turbine 3. A plurality of the turbine stator vanes 32 are attached to the turbine casing 31 and arranged side by side in the turbine circumferential direction Dc. A plurality of the turbine rotor blades 33 are attached to the turbine shaft 4 and arranged side by side in the turbine circumferential direction Dc. The turbine stator vanes 32 and the turbine rotor blades 33 are provided so as to be alternately arranged in the turbine axial direction Da. An exhaust chamber 34 is provided on the rear side of the turbine casing 31 so that exhaust gas is discharged to the outside after the turbine shaft 4 is driven to rotate.

The turbine shaft 4 is supported so as to be rotatable about the axis C by a plurality of bearing units. The end portion of the turbine shaft 4 of the present embodiment that is on the compressor 1 side is supported by a bearing unit 41. The end portion of the turbine shaft 4 of the present embodiment that is on the exhaust chamber 34 side is supported by a bearing unit 42. A generator drive shaft (not shown) is connected to the end portion of the turbine shaft 4 that is on the compressor 1 side.

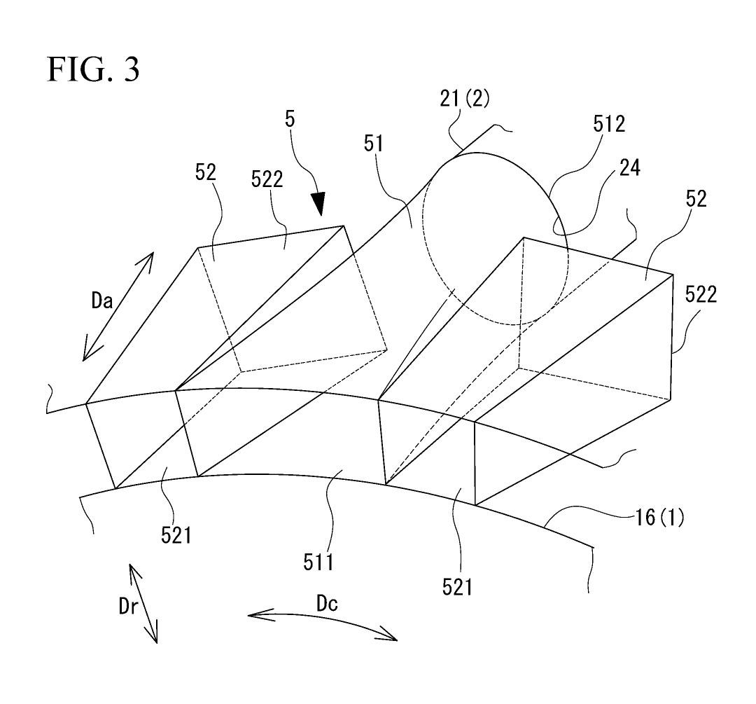

As shown in FIG. 2, a compressor diffuser 5 is connected to the outlet 16 of the compressor 1. As shown in FIG. 3, the compressor diffuser 5 is provided with the combustor diffuser (first diffuser) 51 provided between the compressor 1 and each combustion cylinder 21 and a bleeding diffuser (second diffuser) 52 bleeding the compressed air from the outlet 16 of the compressor 1.

As shown in FIGS. 2 and 3, the combustor diffuser 51 connects the outlet 16 of the compressor 1 and each of the plurality of combustion cylinders 21 disposed around the turbine shaft 4. Here, a plurality of the combustor diffusers 51 are respectively and separately provided on the compressor 1 side in the turbine axial direction Da so as to correspond to the respective combustion cylinders 21 arranged side by side and at intervals in the turbine circumferential direction Dc about the turbine shaft 4. In other words, the combustor diffusers 51 are arranged side by side and at intervals in the turbine circumferential direction Dc about the turbine shaft 4. The combustor diffuser 51 guides the compressed air from the compressor 1 to the combustion cylinder 21 directly and not via the combustor casing R.

The combustor diffuser 51 is formed in a tubular shape. The combustor diffuser 51 extends along the turbine axial direction Da from one end 511 toward the other end 512. The combustor diffuser 51 is formed such that the passage cross-sectional area of the cross section in the turbine radial direction Dr gradually increases from the end 511 toward the other end 512. In other words, the combustor diffuser 51 of the present embodiment converts the dynamic pressure of the compressed air that is generated by the compressor 1 into a static pressure and supplies the static pressure to the combustion cylinder 21 of the combustor 2.

The end 511 of the combustor diffuser 51 is connected to the outlet 16 of the compressor 1. The end 511 of each combustor diffuser 51 is connected to the annular outlet 16 at an interval in the turbine circumferential direction Dc. The end 511 of the combustor diffuser 51 is formed in a fan-shaped opening shape including a double arc portion about the turbine shaft 4 so as to conform to the shape of the outlet 16 of the compressor 1 in the turbine radial direction Dr. The other end 512 of the combustor diffuser 51 is connected to the air supply port 24 of one combustion cylinder 21. The other end 512 of the combustor diffuser 51 is formed in an opening shape that matches the tubular shape of the combustion cylinder 21. In this manner, the combustor diffuser 51 is connected to the compressor 1 and the combustion cylinder 21, and thus the combustor diffuser 51 forms an air passage guiding the compressed air from the compressor 1 to the combustion cylinder 21 directly and without passing through the combustor casing R.

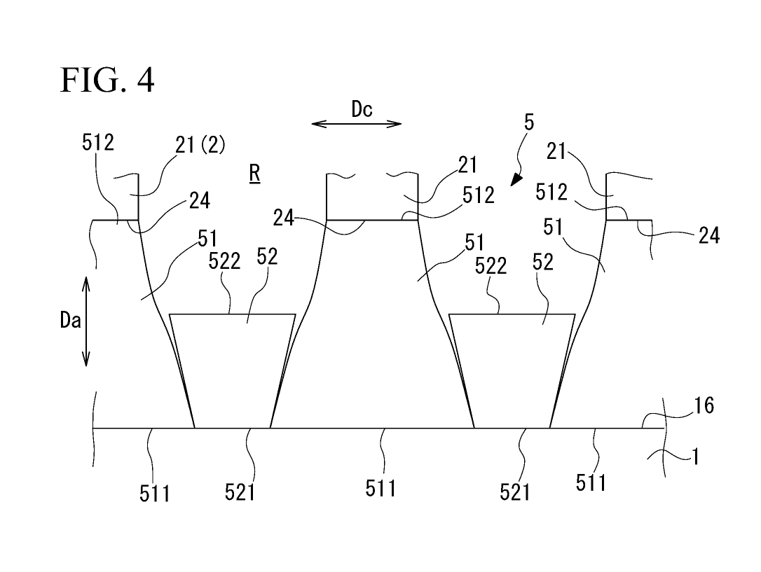

As shown in FIGS. 3 and 4, the bleeding diffuser 52 is connected to the outlet 16 between the combustor diffusers 51 that are adjacent to each other in the turbine circumferential direction Dc. One end 521 of each bleeding diffuser 52 is connected to the outlet 16 in the compressor 1. Each bleeding diffuser 52 is connected at a position different in the turbine circumferential direction Dc from the part in the outlet 16 of the compressor 1 where the end 511 of the combustor diffuser 51 is connected. The end 521 of the bleeding diffuser 52 is formed in a fan-shaped opening shape including a double arc portion about the turbine shaft 4 so as to conform to the shape of the outlet 16 of the compressor 1. The bleeding diffuser 52 has a tubular shape. The bleeding diffuser 52 extends in the turbine axial direction Da from the end 521 toward the other end 522. The dimension of the bleeding diffuser 52 in the turbine axial direction Da is formed so as to be shorter than the dimension of the combustor diffuser 51 in the turbine axial direction Da. The other end 522 of the bleeding diffuser 52 is open in the combustor casing R. The bleeding diffuser 52 is formed such that the passage cross-sectional areas of the cross sections in the turbine radial direction Dr and the turbine circumferential direction Dc gradually increase from the end 521 toward the other end 522. The compressed air that is discharged from the outlet of the compressor 1 is partially supplied to the combustor casing R in the combustor casing 23 by the bleeding diffuser 52.

As shown in FIG. 2, a compressed air passage 291 is formed in the intermediate shaft cover 29 in association with the bleeding diffuser 52. The compressed air passage 291 is connected to, for example, the turbine stator vane 32 and the turbine rotor blade 33. The compressed air that has passed through the compressed air passage 291 is used for cooling of, for example, the turbine stator vane 32, the turbine rotor blade 33, and the turbine shaft 4. In the present embodiment, other objects as well as the turbine stator vane 32, the turbine rotor blade 33, and the turbine shaft 4 may be cooled by the compressed air that has passed through the compressed air passage 291.

As shown in FIG. 1, the gas turbine 10 is provided with a cooling unit 6. The cooling unit 6 cools the compressed air that has been bled from the combustor casing R. The cooling unit 6 is provided with a cooling line 61 and a cooler 62.

A first end 611 of the cooling line 61 is connected to the combustor casing 23 and is in communication with the combustor casing R. A second end 612 of the cooling line 61 is connected to the intermediate shaft cover 29 and is in communication with the compressed air passage 291. The cooling line 61 guides the compressed air of the combustor casing R into the combustor casing R as cooling air. The cooler 62 is provided in the middle of the cooling line 61, cools the compressed air that flows through the cooling line 61, and sends the compressed air into the compressed air passage 291. The cooler 62 of the present embodiment is a heat exchanger such as a TCA cooler.

In the gas turbine 10, the air taken in from the air intake port 11 of the compressor 1 becomes high-temperature and high-pressure compressed air by being compressed through the plurality of compressor stator vanes 13 and compressor rotor blades 14. This compressed air flows into the combustor diffuser 51 from the outlet 16 of the compressor 1. The compressed air that has flowed into the combustor diffuser 51 is directly supplied to the main burner 26 of each combustion cylinder 21. The compressed air supplied to the main burner 26 is mixed with the fuel, is sprayed, and becomes a swirling flow of the premixed gas.

In the pilot burner 25, the mixed compressed air and fuel are ignited and combusted by seed fire (not shown) and become a combustion gas and the combustion gas is sprayed into the combustion cylinder 21. At this time, some of the combustion gas is sprayed into the combustion cylinder 21 so as to be diffused to the surroundings with a flame, and thus the premixed gas that has flowed into the combustion cylinder 21 from each main burner 26 is ignited and combusted. In other words, it is possible to perform flame holding for stably combusting the lean premixed fuel from the main burner 26 with the diffusion flame resulting from the pilot fuel injected from the pilot burner 25.

The fuel is mixed and combusted in the combustion cylinder 21 and the high-temperature and high-pressure combustion gas is generated as a result. The turbine shaft 4 is driven to rotate by this combustion gas passing through the turbine stator vane 32 and the turbine rotor blade 33 of the turbine 3. Power generation is performed by rotational power being applied to a generator connected to the rotationally driven turbine shaft 4. After the turbine shaft 4 is driven to rotate, the exhaust gas is released to the atmosphere through the exhaust chamber 34 as exhaust gas.

The compressed air discharged from the outlet 16 of the compressor 1 partially flows into the combustor casing R from the bleeding diffuser 52 disposed adjacent to the combustor diffuser 51. The combustion cylinder 21 is cooled by the compressed air that has flowed into the combustor casing R. Some of the compressed air that has flowed into the combustor casing R from the bleeding diffuser 52 flows through the cooling line 61, is cooled by the cooler 62, and is supplied to the compressed air passage 291 after being cooled by the cooling unit 6. This cooled compressed air cools, for example, the turbine stator vane 32, the turbine rotor blade 33, and the turbine shaft 4.

In the compressor diffuser 5 and the gas turbine 10 described above, the bleeding diffuser 52 is connected at a position different in the turbine circumferential direction Dc from the part in the outlet 16 of the compressor 1 where the end 511 of the combustor diffuser 51 is connected. By means of this bleeding diffuser 52, some of the compressed air is directly bled from the outlet 16 of the compressor 1 and the compressed air is guided to the combustor casing R outside the combustion cylinder 21. At this time, in the bleeding diffuser 52, the compressed air that has flowed from the outlet 16 of the compressor 1 flows without a change in flow direction. Accordingly, it is possible to limit pressure loss during the bleeding of the compressed air. Further, the pressure of the bled compressed air can be recovered since the bleeding diffuser 52 adopts a shape in which the flow path area increases. As a result, it is possible to limit pressure loss during the partial bleeding of the compressed air sent from the compressor 1 to the combustion cylinder 21 and it is possible to enhance the operation efficiency of the gas turbine 10.

The bleeding diffuser 52 is connected to the outlet 16 of the compressor 1 between the combustor diffusers 51 adjacent to each other in the turbine circumferential direction Dc. With this configuration, the combustor diffuser 51 and the bleeding diffuser 52 can be alternately disposed in the turbine circumferential direction Dc. As a result, the bleeding diffuser 52 is disposed between the combustion cylinder 21 and the combustor diffuser 51 adjacent to each other in the turbine circumferential direction Dc. Accordingly, in the gas turbine 10 provided with the compressor diffuser 5, the bleeding diffuser 52 can be efficiently disposed in the limited space of the combustor casing R.

### Second Embodiment

Next, a second embodiment of the gas turbine of the present invention will be described. A compressor diffuser 5B of the gas turbine 10 shown in the second embodiment is provided with a flow path forming portion 55. Accordingly, in the description of the second embodiment, the same parts as those of the first embodiment are denoted by the same reference numerals without redundant description. In other words, the configuration that the gas turbine 10 has in common with the first embodiment will not be described below.

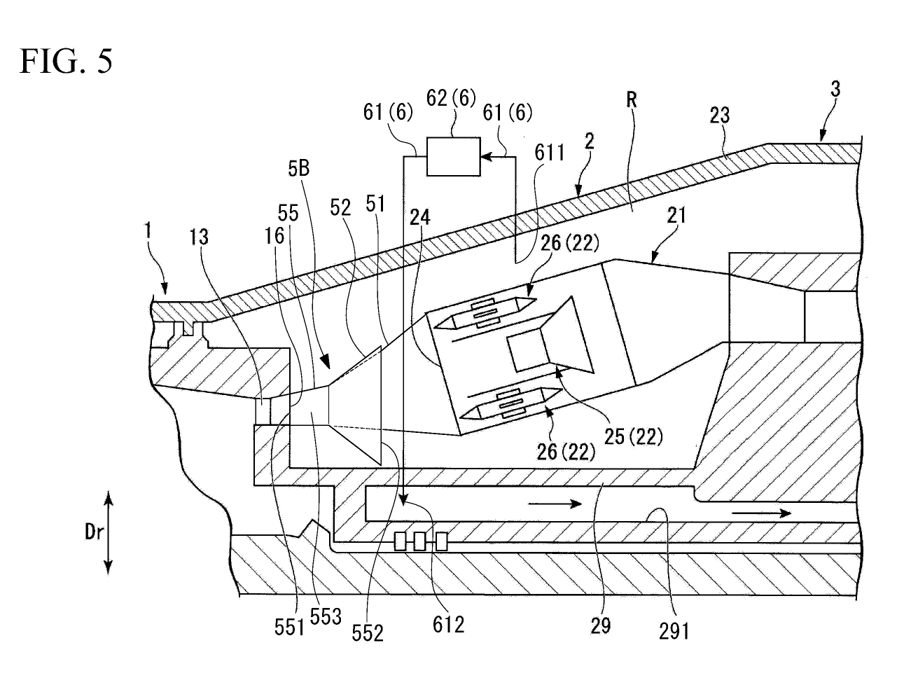

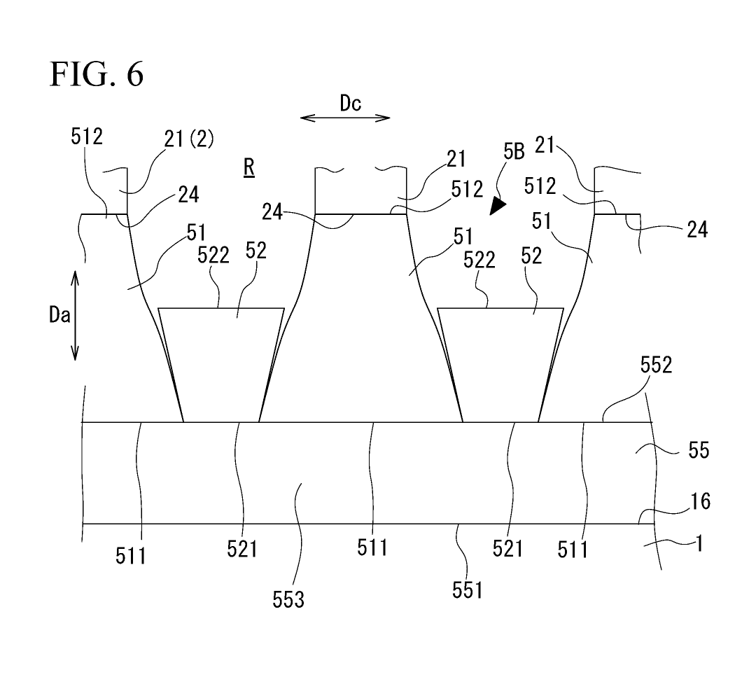

As shown in FIGS. 5 and 6, the compressor diffuser 5B connected to the outlet 16 of the compressor 1 is provided with the flow path forming portion 55 in addition to the combustor diffuser 51 and the bleeding diffuser 52. The flow path forming portion 55 has an annular shape. The flow path forming portion 55 is provided between the outlet 16 of the compressor 1 and the combustor and bleeding diffusers 51 and 52. A first end 551 of the flow path forming portion 55 is connected to the outlet 16 of the compressor 1. A second end 552 of the flow path forming portion 55 is connected to the ends 511 of the plurality of combustor diffusers 51 and the ends 521 of a plurality of the bleeding diffusers 52.

The flow path forming portion 55 extends in the turbine axial direction Da such that the passage cross-sectional area of the cross section in the turbine radial direction Dr gradually increases from the first end 551 toward the second end 552. Formed in the flow path forming portion 55 is an annular flow path 553 continuous with the annular outlet 16. The flow path 553 of the flow path forming portion 55 is continuous (in communication) in the turbine circumferential direction Dc so as to straddle the combustor diffuser 51 and the bleeding diffuser 52 adjacent to each other in the turbine circumferential direction Dc.

In this manner, the end 511 of the combustor diffuser 51 is connected to the outlet 16 of the compressor 1 via the flow path forming portion 55. The end 521 of the bleeding diffuser 52 is connected to the outlet 16 of the compressor 1 via the flow path forming portion 55.

In the gas turbine 10, the air taken in from the air intake port 11 of the compressor 1 becomes high-temperature and high-pressure compressed air by being compressed through the plurality of compressor stator vanes 13 and compressor rotor blades 14. This compressed air flows into the combustor diffuser 51 from the outlet 16 of the compressor 1 via the flow path forming portion 55. At that time, some of the compressed air discharged from the outlet 16 of the compressor 1 flows into the combustor casing R from the bleeding diffuser 52 via the flow path forming portion 55. In other words, the compressed air discharged from the outlet 16 of the compressor 1 flows so as to branch into the combustor diffuser 51 and the bleeding diffuser 52 in the flow path forming portion 55.

In the compressor diffuser 5B and the gas turbine 10 described above, the flow path forming portion 55 is provided so as to straddle the combustor diffuser 51 and the bleeding diffuser 52. Accordingly, the compressed air that has flowed out from the compressed air outlet 16 flows in whole into the annular flow path forming portion 55. The compressed air branches into the combustor diffuser 51 and the bleeding diffuser 52 at the outlet of the flow path forming portion 55. The flow velocity of the compressor air is reduced by the compressed air that has flowed out from the outlet 16 of the compressor 1 flowing once in the flow path forming portion 55. As a result, pressure loss is limited during the compressed air flow into the combustor diffuser 51 and the bleeding diffuser 52 as compared with a case where the combustor diffuser 51 and the bleeding diffuser 52 are directly connected to the outlet 16 of the compressor 1. Accordingly, the operation efficiency of the gas turbine 10 can be enhanced.

The bleeding diffuser 52 is connected at a position different in the turbine circumferential direction Dc from the part in the outlet of the flow path forming portion 55 where the end 511 of the combustor diffuser 51 is connected. By means of this bleeding diffuser 52, some of the compressed air is directly bled. Accordingly, in the gas turbine 10 provided with the compressor diffuser 5, the bleeding diffuser 52 can be efficiently disposed in the limited space of the combustor casing R.

(Modification Example of Second Embodiment)

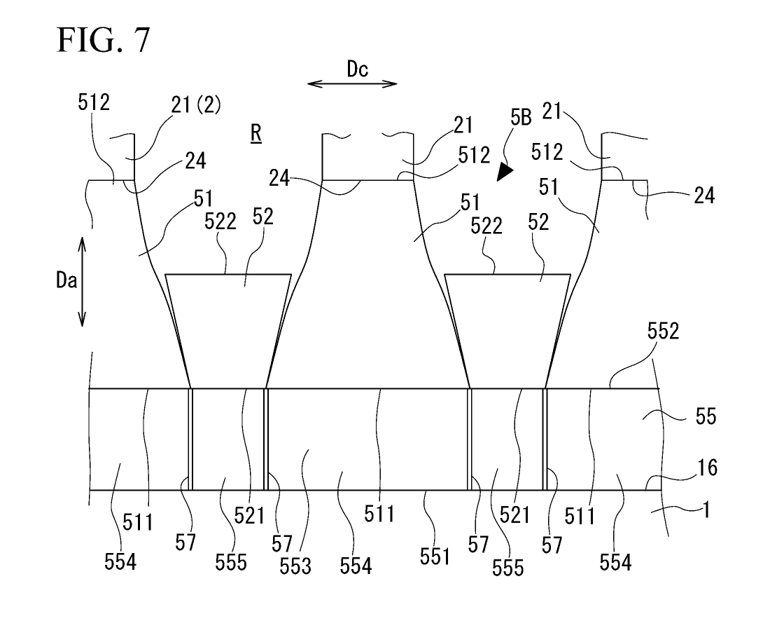

As shown in FIG. 7, in the second embodiment, the flow path forming portion 55 may be provided with a plurality of partition plates 57 such that the flow path 553 formed in the flow path forming portion 55 is partitioned into a plurality of portions in the turbine circumferential direction Dc. For example, the plurality of partition plates 57 may partition the flow path 553 in the flow path forming portion 55 into a combustor flow path portion 554 connected to the combustor diffuser 51 and a bleeding flow path portion 555 connected to the bleeding diffuser 52.

By the partition plate 57 partitioning the flow path 553, the swirl component of the compressed air is removed or reduced as compared with a case where the partition plate 57 is not provided. As a result, rectified compressed air flows into the combustor diffuser 51 and the bleeding diffuser 52. It is possible to limit pressure loss during compressed air inflow particularly in a case where the main operation of the gas turbine 10 is rated operation instead of partial load operation or operation during which start and stop are repeated. Accordingly, the operation efficiency of the gas turbine 10 can be enhanced particularly in a case where rated operation is the main operation.

While preferred embodiments of the invention have been described and shown above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

For example, the shape of the bleeding diffuser 52 is not limited at all and can be changed as appropriate. The objects that are cooled by the compressed air bled by the bleeding diffuser 52 are not limited to the turbine stator vane 32, the turbine rotor blade 33, and the turbine shaft 4. Other parts such as the pilot burner 25 may be cooled by the compressed air as well.

The compressed air bled by the bleeding diffuser 52 is cooled by the cooler 62 of the cooling unit 6 in the embodiment described above. Alternatively, the compressed air may be boosted after flowing into a boost compressor.

According to the present invention, it is possible to limit pressure loss during partial compressed air bleeding.

### EXPLANATION OF REFERENCES

1 Compressor
11 Air intake port
12 Compressor casing
13 Compressor stator vane
14 Compressor rotor blade
15 Inlet
16 Outlet
2 Combustor
21 Combustion cylinder
22 Fuel sprayer
23 Combustor casing
24 Air supply port
25 Pilot burner
26 Main burner
29 Intermediate shaft cover
291 Compressed air passage
3 Turbine
31 Turbine casing
32 Turbine stator vane
33 Turbine rotor blade
34 Exhaust chamber
4 Turbine shaft
41 Bearing unit
42 Bearing unit
5, 5B Compressor diffuser
51 Combustor diffuser (first diffuser)
511 One end
512 The other end
52 Bleeding diffuser (second diffuser)
521 One end
522 The other end
55 Flow path forming portion
551 First end
552 Second end
553 Flow path
554 Combustor flow path portion
555 Bleeding flow path portion
57 Partition plate
6 Cooling unit
10 Gas turbine
61 Cooling line
611 First end
612 Second end
62 Cooler
C Axis
Da Turbine axial direction
Dc Turbine circumferential direction
Dr Turbine radial direction
R Combustor casing

What is claimed is:

1. A compressor diffuser connected to a compressor generating compressed air by compressing air and a combustion cylinder generating a combustion gas by combusting a fuel with the compressed air and supplying the combustion gas to a turbine, the compressor diffuser comprising:
a first diffuser, one end of the first diffuser being connected to a part of an annular outlet of the compressor in a circumferential direction and an other end of the first diffuser being connected to an air supply port of the combustion cylinder; and
a second diffuser connected to a part of the outlet of the compressor at a position different in the circumferential direction from a part where the end of the first diffuser is connected and guiding the compressed air to an outside of the first diffuser.

2. The compressor diffuser according to claim 1,
wherein a plurality of the first diffusers are disposed at intervals in the circumferential direction, and
the second diffuser is disposed between the plurality of the first diffusers adjacent to each other in the circumferential direction.

3. The compressor diffuser according to claim 1, further comprising:
a flow path forming portion connecting the outlet of the compressor and the first and second diffusers and circumferentially continuous so as to straddle at least the first and second diffusers adjacent to each other in the circumferential direction.

4. The compressor diffuser according to claim 3,
wherein the flow path forming portion has a partition plate partitioning a flow path formed in the flow path forming portion in the circumferential direction.

5. A gas turbine comprising:
a compressor generating compressed air by compressing air and sending out the compressed air from an annular outlet;
a combustion cylinder generating a combustion gas by combusting a fuel in the compressed air and supplying the combustion gas to a turbine;
a turbine having a rotor blade driven to rotate by the combustion gas; and
the compressor diffuser according to claim 1 provided between the compressor and the combustion cylinder.
